(19) United States
(12) Patent Application Publication
(10) Pub. No.: US 2025/0346058 A1
(43) Pub. Date: Nov. 13, 2025

(54) SECURITY ELEMENT WITH COLORSHIFT

(71) Applicant: THALES DIS FRANCE SAS, Meudon (FR)

(72) Inventors: Teemu POHJOLA, Espoo (FI); Jenni ANJALA, Helsinki (FI); Toni KASKIALA, Helsinki (FI); Mikko LANKINEN, Helsinki (FI); Jukka MÖKSY, Vantaa (FI)

(73) Assignee: THALES DIS FRANCE SAS, Meudon (FR)

(21) Appl. No.: 18/860,051

(22) PCT Filed: Apr. 28, 2023
(86) PCT No.: PCT/EP2023/061416

§ 371 Date: Oct. 25, 2024

(30) Foreign Application Priority Data
Apr. 29, 2022 (EP) 22305645.8

(51) Int. Cl. B42D 25/324; B41M 3/14; B42D 25/23; B42D 25/24; B42D 25/435; B42D 25/46

(52) U.S. Cl. CPC B42D 25/324; B41M 3/148; B42D 25/23; B42D 25/24; B42D 25/435; B42D 25/46

(57) ABSTRACT

Provided is a data carrier for a secure article such as a passport comprises a carrier body and at least one security element being provided on the carrier body. The security element comprises at least one surface structure extending along at least one extension direction (E) and at least one print being at least partially arranged on the surface structure. The security element, in the region of the surface structure, is configured to exhibit different appearances when being observed under different viewing angles. Other embodiments are disclosed.

### TECHNICAL FIELD

The present invention relates to a data carrier according to claim 1, to a secure article comprising or consisting of a data carrier according to claim 13, and to a method of producing a data carrier according to claim 14.

### PRIOR ART

Most identity and travel documents are based on polycarbonate substrate personalized with a laser into the inner layers of the document such that forgers cannot access it to change or remove it. This type of personalization normally leads to gray scale images only while a part of the market requires color photographs.

A new trend in personalizing polycarbonate documents with color is to use inkjet printing onto the surface of the documents. This approach leaves the personalization vulnerable to removal and tampering attempts.

### SUMMARY OF THE INVENTION

It is an object of the present invention to provide a data carrier comprising a print of increased security.

This object is achieved with a data carrier according to claim 1. That is, a data carrier for a secure article such as a passport is provided, wherein the data carrier comprises a carrier body and at least one security element being provided on the carrier body. The security element comprises at least one surface structure extending along at least one extension direction and at least one print being at least partially arranged on the surface structure. The security element, in the region of the surface structure, is configured to exhibit different appearances when being observed under different viewing angles.

The print particularly preferably corresponds to an inkjet print. However, inkjet is not the only option. Instead, other prints such as UV curable varnish prints or silk screen press prints etc. are likewise conceivable. As such, any explanations made herein regarding an inkjet print likewise apply to other prints and vice versa.

The inkjet print is provided by inkjet printing as it is commonly known in the state of the art. It is particularly preferred that the inkjet print is provided by drop-on-demand (DoD) inkjet printing, wherein droplets of ink are propelled from an inkjet printer. The inkjet printer preferably is a commercially available inkjet printer. It is furthermore preferred that the inkjet print is recreated based on a data set being input to the inkjet printer. This step can be referred to as preprocessing step. In other words, the inkjet print preferably is a recreation of a digital image and/or a digital alphanumeric character.

Thus, the print such as the inkjet print preferably has the shape of an image and/or an alphanumeric character. Non-exhaustive examples of an image are a portrait or photograph or biometric information such as a fingerprint e.g. of the holder of the data carrier, an outline of a country, a state coat of arms, a state flag, a signature panel, geometric objects such as lines, circles, a graphical representation of an encoded information such as a bar code or a QR code, etc. Non-exhaustive examples of alphanumeric characters are a date of birth, a name, a social security number e.g. of the holder of the data carrier, an expiry date, etc. Hence, the print preferably serves the purpose of attributing personalized information such as personal data of the holder of the data carrier to the data carrier.

The at least partial provision of said print on the surface structure results in said part or parts of the print appearing as a so-called optically variable print. That is, the appearance of the print in said part or parts depends from a viewing angle under which the security element is observed by an observer. For instance, when the print corresponds to blue colour, the print could appear in light blue under a first viewing angle and could be split into parts of darker and yet lighter blue under a second viewing angle being different from the first viewing angle. In this case, the light blue appearance can be referred to as first appearance and the darker and yet lighter blue appearance can be referred to as second appearance being different from the first appearance. The security element can thus be said to exhibit an colourshift.

The printer is configured to jet droplets of a particular dimension and with a particular density. The density of the droplets is also referred to as dots per inch (DPI) or lines per inch (LPI) or pixels per inch (PPI) for instance, which are a measure of a printing resolution of the printer. For instance, the print can be said to comprise pixels that are printed with a resolution of PPI (pixels per inch) which applies in two spatial direction such as an x direction and a y direction of the print while LPI defines the resolution/repetition of pixels in one spatial direction, e.g. the y direction (lines being horizontal or along the x direction).

The printing resolution, in particular the DPI or the LPI, is preferably defined with respect to the extension direction, e.g. the print preferably comprises DPI or LPI that run along the extension direction.

The print can be printed while a print head of the printer is stationary and the data carrier is moved relative to the print head. The movement of the data carrier may be used to control the print resolution in the printing direction. This is commonly known as single pass printing. However, it is likewise conceivable that the print head is moved, i.e. scanned, while the print is printed.

The extension direction preferably extends parallel to a surface plane of the data carrier. The surface plane of the data carrier in turn preferably extends along a surface of the data carrier, for instance through a top surface of the data carrier. The top surface of the data carrier preferably provides a top side of the data carrier.

The appearances preferably correspond to colour appearances such a colour itself, an intensity or brightness of a colour, etc.

The surface structure preferably comprises elevations extending away from the carrier body and/or depressions extending towards the carrier body.

The carrier body preferably comprises a surface, wherein the surface structure is preferably provided on said surface.

To this end it is particularly preferred that the surface structure is provided in the form of elevations extending away from the surface of the carrier body and towards an outside of the data carrier and/or depressions extending oppositely and towards the surface of the carrier body, respectively. In other words, the surface structure preferably comprises a non-flat surface.

A size of the elevations and/or a size of the depressions is preferably associated with a size of a droplet and/or with the density of the droplets i.e. the dots per inch (DPI) and/or with the lines per inch (LPI) and/or with the pixels per inch (PPI), and/or with the printing resolution of the printer.

In particular, it is preferred that the size of the droplets and/or the DPI and/or the LPI define the size of the elevations and/or the depressions.

The print can be printed at various printing resolutions. For instance, the print could comprise a printing resolution of 300 dpi, 360 dpi, 600 dpi, 720 dpi, etc., but also up to 1200 dpi, 1440 dpi or even double of these such as 2400 dpi or 2880 dpi.

The printing resolution preferably defines a line with of the print. For instance, a printing resolution of 600 dpi gives a line width of 42.3 μm, wherein higher printing resolutions result in respectively smaller line widths.

As will be explained in greater detail below, the surface structure is preferably associated with a surface structure pitch. The surface structure pitch of the surface structure is preferably equal to or essentially equal to one or more, i.e. a multiple of the line width. For instance, the surface structure pitch of the surface structure could be two times, four times or 8 times, etc., the line width. It should be noted that odd multiples (1×, 5×, . . . ) of the line width are likewise conceivable.

It is furthermore preferred that a dot resolution of the printer is larger than the printing resolution in pixels per inch or lines per inch to achieve variable color tones per pixel. For instance, the print could have a printing resolution of 600 or 720 pixels per inch and lines per inch, while the dot resolution of the printer could be 2400 dpi in order to have a grid/matrix of 4×4 dots per pixel to represent different color tones in that pixel.

The surface structure is defined by three dimensions. One dimension is preferably associated with the size of the security element which can be the size of the print or a bit bigger to allow for small misregistration of the print or smaller. The second dimension is preferably associated with a width of the components constituting the surface structure, e.g. the depressions or elevations or individual ridges (see further below) of the surface structure and this is the preferably furthermore the dimension to relate with the printing resolution.

As will be explained in greater detail further below in the context of the surface structure pitch and its association with the printing resolution, different operating regimes can be applied. For instance, the said second dimension can be matched to the printing, wherein the different appearances of the security element preferably are flip effects. However, it is likewise preferred to have a mismatch of the surface structure pitch and the pitch of the print to give rise to other effects such as a line Moire effect. The Moire effect is characterized by Moire period which preferably has at most the size of the security element for a clear motion effect. The Moire period p_M is calculated from the pitches p_st (surface structure) and p_lpi (print) as p_M=p_st*p_lpi/|p_st−p_lpi|, wherein the denominator is the absolute value of the difference of the two pitches. This in turn gives for two almost matching pitches the following examples: 10% mismatch (p_lpi=0,9*p_st) leads to p_M=9*p_st and 1% mismatch gives p_M=99*p_st. If p_st=171 μm for example (4× the line width of 600 lpi print+1%), these periods turn out to be 1.5 mm and 16.9 mm, respectively. A preferred mismatch between the pitches is preferably in the range of 1-5%. It should be noted that if the pitch is for instance halved to 85.5 μm (2× the line width of the print) the same Moire periods are achieved with a mismatch of 0.5-2.5% so the physical dimensions depend on each other.

The third dimension is preferably associated with a height of the surface structure (for instance by how much the elevations extend from a surface of the carrier body or by how much the depressions extend towards the carrier body, see below) which typically depends on the process of making the surface structure such as embossing and has an impact on the viewing angles and thus the actual optically variable effect. A height of the surface structure is preferably in the range of 10-100% of the p_st, more preferably in the range 10-50%, and particularly preferably in the range of 15-30%. These ranges preferably apply to a surface structure having the shape of ridges. Other shapes of the surface structure could be associated with the same or different ranges.

In any case, the surface structure preferably has a surface structure pitch up to 1 millimeter and/or is in the range of 100 micrometer to 1 millimeter, for instance in the range of 100 micrometer to 400 micrometer, more preferably in the range of 150-200 μm. Moreover, in any case it is preferred that the surface structure preferably has a height of up to 400 micrometer and/or is in the range of 1 micrometer to 400 micrometer, for instance in the range of 15-50 μm. The particular values preferably depend on the material the data carrier, in particular the carrier body, is made of. For instance, if the data carrier corresponds to a laminated plastic such as polycarbonate product, the surface structure preferably has a surface structure pitch of up to 400 μm and/or the height of the surface structure preferably is up to 40 μm and/or a line width of the surface structure preferably is up to 400 μm. If the data carrier corresponds to a paper product, the surface structure pitch preferably is up to 1 mm and/or a height such as a height of the elevation/depression is preferably up to 200 μm.

Additionally or alternatively, a height by which the elevations extend from the surface of the carrier body preferably is in the range of 1 micrometer to 1 millimeter or smaller. To this end, the elevations can have a same height or a different height.

Likewise, a height by which the depressions extend towards the carrier body preferably is in the range of 1 micrometer to1 millimeter or smaller. The depressions can have a same height or a different height.

A size of the surface structure is preferably variable. For instance, the surface structure could cover the whole datapage/card area, which would mean a max size of 125×85 or 85,6×54 mm respectively. However, smaller sizes such as 50 mm×50 mm or less are preferred. The size preferably corresponds to a maximum size of the print such as the portrait and some additional space for registration purposes. For paper products the surface structure could technically also cover the whole passport paper page (125×85 mm) for instance. However, smaller sizes such as 50 mm×50 mm or less are preferred. However, it is likewise conceivable that only part of the print is arranged on the surface structure.

Furthermore, and as mentioned earlier, a line width of the surface structure line in the event of a plastic product preferably is in the range of 25 μm to 400 μm and in the event of a paper product preferably in the range of 25 μm to 1 mm, respectively.

Various designs of the surface structure are conceivable. For instance, the surface structure can have an essentially round shape, a pyramidal shape, a curved shape, the shape of a slope or steps, a serrated shape, etc., when seen in cross-section. In the latter case, the surface structure can be said to have a saw-tooth-like or zig-zag shape. The design of the surface structure is preferably defined by the particular arrangement of its elevations and depressions, respectively. Furthermore, the surface structure can be symmetrical or asymmetrical.

For example, the surface structure can comprise ridges that are arranged next to one another with respect to the extension direction. This arrangement of the ridges is understood as a surface structure extending along the extension direction, wherein the ridges themselves can extend along another direction, for instance along a direction extending perpendicularly to the extension direction of the surface structure. Furthermore, the ridges can extend parallel or non-parallel to one another. In addition, the ridges may vary from one another or could have one type of ridge profile and pitch, herein called surface structure pitch, repeated across the entire surface structure or could be composed of areas that differ from one another. These explanations or course likewise apply to surface structures comprising another profile than ridges.

A distance between and/or a surface area of and/or a slope of the elevations remains constant or changes with respect to the extension direction. Additionally or alternatively a distance between and/or a surface area of and/or a slope of the depressions remains constant or changes with respect to the extension direction.

A changing distance and/or changing surface area and/or changing slope can be present between successive elevations and/or depressions. Alternatively, it is likewise conceivable that said changing distance and/or changing surface area and/or changing slope is present between non-successive elevations and/or non-successive depressions.

A distance between successive elevations or successive depressions preferably is in the range of 25 micrometer to 400 micrometer in the event of plastic products and/or in the range of 25 micrometer to 1 millimeter in the event of paper products.

The slope of an elevation refers to the slope by which the elevation extends from the carrier body, in particular from its surface, when seen along the extension direction. Likewise, the slope of a depression refers to the slope by which the depression extends towards the carrier body, in particular towards its surface. The slope of an elevation and/or a depression preferably is in the range of 0 degrees to 50 degrees, more preferably between 5 degrees to 30 degrees. In other words, the elevation can be said to enclose an angle between the surface of the elevation and the surface of the carrier body. Likewise, the depression can be said to enclose an angle between the surface of the depression and the surface of the carrier body.

The surface structure is preferably associated with a surface structure pitch and the print is associated with a printing resolution, wherein the surface structure pitch and the printing resolution match or mismatch one another.

A surface structure pitch matching the printing resolution means that the print is registered to the surface structure pitch. As explained earlier, the printing resolution is associated with the size of the droplets and/or the DPI and/or the LPI and/or the PPI.

In other words, it is preferred that a dimension or phase of the surface pattern matches or essentially matches a dimension or phase of the print. However, it is likewise conceivable that the surface structure pitch mismatches the printing resolution. In other words, it is likewise preferred that a dimension or phase of the surface pattern mismatches a dimension or phase of the print. This latter case is particularly preferred for generating a security element exhibiting a Moire effect.

Moreover, in order to produce a desired effect in the appearances a matching of the pitches preferably furthermore requires that a position of the print is matched such that in every data carrier printed a first line lies exactly on e.g. an upper or lower side of a ridge. Otherwise any two data carrier will differ randomly from each other and may show only minimal optical variability if any.

The print preferably comprises at least a first colour. A density of the first colour on the surface structure preferably remains constant or varies with respect to the extension direction. Additionally or alternatively, the first colour and the surface structure are preferably arranged in a spatial relationship with one another.

The colour preferably corresponds to a basic ink as commonly used in printing, i.e. the colour preferably is Cyan, Magenta, Yellow, or Black.

The density of the first colour is understood as an amount of droplets of the first colour per surface area of the surface structure. In other words, the dots per inch of the first colour on the surface structure preferably remains constant or varies with respect to the extension direction.

A changing density can be a density that continuously changes with respect to the extension direction or that intermittently changes with respect to the extension direction. For instance, in the former case the amount of droplets of the first colour could continuously decrease with respect to the extension direction. In the latter case, the amount of droplets of the first colour could increase and thereafter decrease and thereafter again increase with respect to the extension direction.

To this end it is preferred that the density of the first colour on the elevations and/or the depressions of the surface structure remains constant or varies with respect to the extension direction. That is, it is preferred that an amount of droplets of the first colour per surface area of the elevations or of the depressions remains constant or changes with respect to the extension direction. For instance, the same amount of droplets of the first colour could be provided on all elevations (depressions) with respect to the extension direction. Likewise, a changing amount of droplets of the first colour could be provided on the elevations (depressions) with respect to the extension direction. For instance, every second elevation (depression) could comprise droplets of the first colour whereas the other elevations (depressions) do not comprise droplets of the first colour. In other words, the density of the first colour on a first set of elevations is preferably different from the density of the first colour on a second set of the elevations. Additionally or alternatively the density of the first colour on a first set of depressions is preferably different from the density of the first colour on a second set of depressions.

In other words, and as mentioned earlier, the surface structure can comprise elevations and depressions, and wherein the elevation can be seen as a ridge with ‘positive’ and ‘negative’ slopes in the extension direction and wherein the depression can be seen as a groove with ‘negative’ and ‘positive’ slopes in the extension direction, respectively. To this end the print is preferably controlled and altered such that, for example, the density of the first colour is increased on the positive slopes while the density of the first colour is reduced on the negative slopes.

In particular, the security element is particularly preferably configured such that a varying appearance such as a variation of the color of the security element is observed when being observed under different viewing angles, for instance upon tilting the data carrier. As such, it is particularly preferred to provide one or more colours on top of a ridge of the surface structure which are not disappearing upon tilt and furthermore to provide one or more colours at the bottom of a groove that are not hidden by the structure. If the ink density varies between the up and down slopes the viewer sees a clearer variation upon the tilt (slope that is towards the viewer remains visible, while the visibility of the ink on the slope away from the viewer reduces quickly with the tilting motion.

The spatial relationship is preferably based on a printing resolution of the printer and/or is preferably associated with the size of the droplets and/or the DPI and/or the LPI and/or the PPI. To this end it is particularly preferred that the first colour and the elevations and/or the depressions are arranged in a spatial relationship with one another. A preferred spatial relationship between the first colour and the surface structure, in particular the elevations and/or depressions, preferably corresponds to a simple or a multiple of the printing resolution of the printer and/or the size of the droplets and/or the DPI and/or the LPI. For example, if the first colour is blue and a width of a line is 50 micrometer, the preprocessing can have a blue line or blue pixels in one such line or not. Then, for example, blue color could be printed to every second such line only.

It should be noted that these explanations likewise apply to the case wherein the print comprises two or more colours.

The print can comprise at least a first colour and a second colour being different from the first colour. A density of said first colour on the surface structure preferably equals or differs from a density of said second colour on the surface structure with respect to the extension direction.

That is, it is conceivable that the print comprises more than one colour such as two colours, for instance red and blue.

In this regard it should be noted that a droplet being jetted from the printer preferably comprises two or more colours. For instance, one droplet could comprise at least two of cyan, magenta, yellow and black. Furthermore, the print must not necessarily consist of very structured pixels or printed lines. Instead, the print could comprise one or more arrays of different CMY(K) colour droplets.

To this end a density of these two or more colours, i.e. an amount of droplets of the individual colours, can be the same or different from one another with respect to the extension direction. In other words, the dots per inch of the colours on the surface structure can be the same or different from one another with respect to the extension direction. For instance, the first and second colours could be arranged with uniform densities on a first region of the surface structure and with varying densities on another region of the surface structure, i.e. the density of the colour components of the print such as of red and blue colour could be varied.

However, and as will be explained in greater detail below, it is likewise conceivable that the initial image and/or initial alphanumeric character to be applied as print such as a photograph for example comprises an appearance being constituted by predefined colours, and wherein the density of the colours in the print is then altered such that a local colour appearance of the security element does not seem to change. For instance one pixel colour could be changed to be darker while a neighbouring colour pixel could be changed to be lighter, however while keeping their average same as the initial image and/or initial alphanumeric character. Said print is furthermore preferably arranged according to and depending on the surface structure such that the local color variations match the surface structure and while the appearance of the security element remains unchanged when the security element is viewed under a first viewing angle such as viewed from directly above, whereas the security element exhibits a variable color effect upon tilting the data carrier and observing the security element under a different viewing angle.

An image and/or an alphanumeric character to be printed as the print in an initial state before being printed on the surface structure is preferably associated with an initial appearance being provided by at least a first colour and a second colour. Moreover, the first colour and the second colour are preferably arranged on the surface structure with different densities such, that the security element exhibits an appearance corresponding to the initial appearance when being observed under a first viewing angle while exhibiting a different appearance when being observed under a different viewing angle.

That is, before printing the image and/or alphanumeric character to be printed can be preprocessed by changing one or more of the colours or colour channels (Cyan, Magenta, Yellow) in location(s) where one desires a color variable effect in the security element. In said preprocessing step a density, i.e. a colour intensity, of certain pixels such as of neighbouring pixels is changed such that an average color tone is maintained while a colour intensity is increased at one or more locations while the colour intensity is decreased at one or more other locations of the surface structure. In the event of a surface structure comprising the above-mentioned ridges or the like it is of course likewise conceivable to change a density or colour intensity of lines of pixels. For instance, in the event of a surface structure comprising a parallel x-directional ridge pattern the intensity of lines of pixels (assuming that the image and/or alphanumeric character is composed of x directional lines which could be identified with a line index in the y coordinate direction y1, y2, . . . ) such that an average color tone is maintained while the intensity of for example every second line is increased and the intensity of the other every second line is reduced.

in the event of the exemplary surface structure comprising ridges mentioned above, the surface structure could be composed of parallel ridges having a surface structure pitch and cross sectional profile remaining constant, and further that the ridges extend in a direction here called x direction. In the event that the print is in register with the surface structure the surface structure pitch is matched to the printing resolution in the extension direction, herein called y direction, wherein, for instance, a darker line could be arranged on an upper slope of each ridge and a lighter line could be arranged on a lower slope (upper/lower in y direction) for a maximum color variation effect. However, it is likewise conceivable that the print and the surface structure pith are not in perfect register, i.e. that there is a mismatch or misregistration. In this case there is a mismatch in between the printing resolution and the surface structure pitch. In this way there could be the situation where at a bottom of the image and/or alphanumeric character (or a part overlapping with the surface structure) darker lines coincide with lower slopes but when moving upwards they first move towards a top of the ridges, then over to upper slopes, then to grooves in between the ridges etc. to create a Moire effect. In the following an example for each case is given. Assuming it is target to print with 500 lines per inch along the extension direction or y direction, respectively. This corresponds to a line width of 50.8 micrometer and an exactly matching surface structure pitch would be a single or multiple of it, namely 50.8 micrometer, 101.6 micrometer, etc. A mismatch in order to generate a Moire effect, for instance, is created by tuning the pitch to an offset, e.g. at 50 micrometer or 52 micrometer. The exact offset value will define parameters of the Moire effect such as the Moire period (spatial period/distance over which the darker color tone repeats itself). It is furthermore preferred that the profile of the surface structure is symmetrical and either with straight or curved slopes, straight slopes emphasizing the effect more. The height of the ridges is then defined by the width, the shape and the desired angle of the slopes.

In any case it is furthermore conceivable that the surface structure and a preprocessing of the image and/or the alphanumeric character is varied in both x and y directions.

The data carrier preferably further comprises at least one marking material being configured to interact with impinging laser radiation, and wherein the surface structure corresponds to a laser marking being generated in the marking material, or wherein the surface structure corresponds to an embossing.

The carrier body and/or the surface structure preferably comprises or consists of one or more paper-based compounds and/or one or more cardboard-based compounds and/or one or more plastics and/or one or more polymers, preferably one or more thermoplastics and/or amorphous polymers, particularly preferably polycarbonate and/or polycarbonate blends and/or polycarbonate co-extrudates.

The carrier body preferably comprises one or more layers of at least one of a paper-based compound, a cardboard-based compound, a plastics or a polymer. Two or more layers are preferably connected to one another by means commonly known in the state of the art. For instance, if the carrier body comprises two or more layers comprising or consisting of polymers and/or plastics, these layers could be connected to one another via lamination. In this case, the carrier body preferably corresponds to a so-called card body as it is commonly known in the card industry. However, other types of layers and/or connection means are likewise conceivable. For instance, layers of a paper-based compound could be glued to one another. In this regard it should be noted that a typical application for paper-based compounds is a visa page or a passport booklet where the only occasion of connecting a paper layer with the other elements is in the cover and then the other element may be an inlay which may be built with layers of paper, ‘artificial paper’ or plastic and it may be directly the passport cover which again may have different material layers to it. The attachment in each case is nevertheless by gluing.

In the event that the data carrier comprises the marking material, it is preferred to provide the marking material after the carrier body is generated on a surface of the carrier body, in particular on a top surface of the carrier body. To this end it is preferred that the marking material is provided as one or more layers as well. The marking material particularly preferably corresponds to polycarbonate or another plastic that preferably comprises laser sensitive additives. Once that the marking material is provided on the carrier body, it is preferred to generate the surface structure in the marking material by irradiating laser radiation onto the marking material. In regions of impingement of the laser radiation, the marking material is preferably colour-changed around the laser sensitive additives, and

wherein a strong reaction can result in a foam like structure that extends up from a surface of the data carrier. Such marking is typically black and is generally known as tactile laser marking. With some lasers and/or laser settings it is possible to achieve also whitish tactile marking.

However, it is likewise conceivable that no such marking material is present. In this case, it is preferred that the surface structure is produced in the carrier body itself, preferably by embossing a structure into the carrier body, particularly preferably into the top surface of the carrier body. For instance, said structure could be provided on a lamination plate that is used to laminate the layers of the card body, wherein the structure is embossed into the carrier body and the surface structure in the form of an embossing is generated. As such, it is preferred that the surface structure is an integral component, i.e. formed into, the top surface of the carrier body.

However, the surface structure can likewise correspond to a print, preferably an inkjet print. Said print is preferably printed on a surface of the carrier body as just mentioned.

The surface structure being a print preferably corresponds to a three-dimensional profile being printed. Said surface structure can be generated in different ways such as by inkjet printing, intaglio printing or lamination, tactile laser marking or printing.

That is, in the event of a plastic product it is preferred that a plastic surface is embossed for instance by heat and that pressure using a structured lamination plate surface against the substrate surface is applied. In the event of a paper product, it is preferred to use a specific printing process that similarly uses structured plates and high pressure (not heat), which is also known as Intaglio printing. However, it is likewise conceivable to use plates only and no ink, wherein an embossing in the paper surface being similar to the lamination of the plastic surface is achieved.

It is noted here that further techniques for creating embossings or a raised print on a paper product as they are known in the state of the art are likewise conceivable. For instance, typesetting or letterpress used like the Intaglio could be used to simply press the paper product with a patterned plate. Alternatively, UV curable varnish printed in letterpress, silk screen press or in inkjet printing could be used. In particular, any known means to emboss the paper product itself or to print a raised print pattern are conceivable.

The data carrier preferably defines a top side, and wherein the security element is provided on the top side the data carrier.

The security element is particularly preferably provided on a top surface, i.e. the outermost surface, of the data carrier. As such, it is preferred that the security element is arranged on the data carrier so as to face towards an outside of the data carrier.

Said top surface of the data carrier preferably corresponds to the top surface of the carrier body or to the marking material. Consequently, in the former case, it is preferred that the surface structure is an integral component of the top surface of the data carrier. In the latter case, it is preferred that the marking component and thus the surface structure is arranged on the top surface of the data carrier.

The data carrier preferably further comprises at least one further surface structure being different from the surface structure, and wherein the print is furthermore at least partially arranged on said further surface structure.

Any explanations made herein regarding the surface structure preferably likewise apply to the further surface structure and vice versa.

The security element, in the region of the further surface structure, is preferably configured to exhibit different appearances when being observed under different viewing angles.

The surface structure and the further surface structure can be arranged immediately adjacent from one another or at a distance from one another.

The security element is preferably configured such, that one or more appearances of the security element in the region of the surface structure can be the same or different from one or more appearances of the security element in the region of the surface structure when being observed under particular one or more viewing angles.

The further surface structure preferably comprises further elevations extending away from the carrier body and/or further depressions extending towards the carrier body with respect to the further extension direction, and wherein at least one of a distance, a surface area, a slope, a cross-section, a surface structure pitch, etc. of the further elevations and/or of the further depressions equals or differs from at least one of the distance, the surface area, the slope of the elevations and/or of the depressions, the cross-section, the surface structure pitch, etc. of the surface structure.

That is, the further surface structure preferably comprises elevations, herein called further elevations, and depressions, herein called further depressions, like it is the case with the surface structure and as explained previously. To this end it is conceivable that a distance and/or a surface area and/or a slope of the further elevations of the further surface structure equals or differs from the distance and/or the surface area and/or the slope of the elevations of the surface structure. Likewise it is conceivable that a distance and/or a surface area and/or a slope of the further depressions of the further surface structure equals or differs from the distance and/or the surface area and/or the slope of the depressions of the surface structure.

The further surface structure preferably extends along the extension direction. That is, the further surface structure can be seen as a shift or translation in the extension direction with respect to the surface structure. To this end it is particularly preferred that the further surface structure differs in at least one of the parameters defining the security element such as the pitch, slopes, cross section of the ridges, the print pre-processing parameters, e.g. how the color density is altered by the pre-processing algorithm, etc. For instance, the further surface structure could be identical to the surface structure except that it is moved/translated along the extension direction by a fraction of the pitch to achieve a phase difference to the optical effect being observed.

The further surface structure can however likewise extends along at least one further extension direction being different from the extension direction.

The further extension direction preferably extends parallel to the surface plane of the data carrier mentioned initially. Moreover, the extension direction and the further extension direction preferably run within a plane extending parallel to the top surface of the carrier body or the data carrier. In particular, the extension direction and the further extension direction preferably run within a common plane, and wherein said common plane extend parallel to the top surface of the carrier body or the data carrier. The extension direction and the further extension direction preferably run at an angle with respect to one another. For instance, the extension direction could run parallel to an edge of the carrier body, whereas the further extension direction runs at an angle with respect to said edge. A preferred angle is 90 degrees.

The print preferably comprises at least a first colour, and wherein a density of the first colour on the surface structure with respect to the extension direction equals or differs from a density of the first colour on the further surface structure with respect to the extension direction, in the event that the further surface structure extends along the extension direction, and/or the further extension direction, in the event that the further surface structure extends along the further extension direction. Additionally or alternatively, the print preferably comprises at least a first colour being arranged on the surface structure and a further colour being arranged on the further surface structure, the first colour and the further colour differing from one another.

That is, the surface structure and the further surface structure can be provided in regions of the print of different colour. For instance, the surface structure could be arranged in a region of the print that consists of red droplets of ink and the further surface structure could be arranged in a region of the print that consists of blue droplets of ink. In this regard it is noted that if the print to be printed is the same in all data carriers e.g. a flag or it is preferred to match the thus predefined colors with dedicated surface structures. If the surface structures are created with tactile laser marking or by special inkjet print it is preferred that the surface structures are defined based on the inkjet print to be printed and not the other way around.

However, it is likewise conceivable that the surface structure and the further surface structure are arranged in a region of the print that consists of the same colour, e.g. both could be arranged within a region of the print that consists of red droplets of ink. To this end it is conceivable that a density, e.g. an amount of red droplets of the ink per surface area of the (further) surface structure, is the same on both surface structures or differs among the surface structures.

In a further aspect a secure article comprising or consisting of at least one data carrier as described above is provided. The secure article preferably is an identity card, a passport, a credit card, a smart card, a driving license, a data page or the like.

It should be understood that the data carrier per se can correspond to a secure article. This is the case if the data carrier is provided in the form of an identity card, for example. However, it is likewise conceivable to introduce or incorporate the data carrier into a secure article. In the case of a passport for example the data carrier could correspond to or could be incorporated in a page of the passport.

Any explanations provided with regard to the data carrier per se likewise apply to the secure article and vice versa.

In a further aspect a method of producing a data carrier for a secure article such as a passport, is provided. The data carrier preferably is a data carrier as described above. The method comprises the steps of i) providing a carrier body, and ii) providing at least one security element on the carrier body. The security element comprises at least one surface structure extending along at least one extension direction and a print being at least partially provided on the surface structure. The security element, in the region of the surface structure, is configured to exhibit different appearances when being observed under different viewing angles.

Any explanations made with regard to the data carrier and the secure article likewise apply to the method and vice versa.

The method preferably further comprises the step of providing at least one marking material being configured to interact with impinging laser radiation on the carrier body and generating the surface structure as a laser marking by irradiating laser radiation onto the marking material.

Likewise, the method preferably comprises the step of embossing preferably a structure on a lamination plate into a surface of the carrier body and generating the surface structure as embossing. The print and the embossing are preferably generated based on a same data set being input to a printer and a lamination device comprising the lamination plate.

Likewise, the method preferably comprises the step of printing, in particular printing, a surface structure onto the surface of the carrier body.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a top view on a data carrier comprising a security element according to the state on the art;

FIG. 2 shows a side view on the data carrier according to FIG. 1;

FIG. 3a shows a top view on a data carrier comprising a security element according to the invention;

FIG. 3b shows a sectional view through the data carrier according to FIG. 3a at the position A-A;

FIG. 3c shows the data carrier according to FIG. 3a when being observed under a first viewing angle;

FIG. 3d shows the security element of the data carrier according to FIG. 3a when being observed under the first viewing angle;

FIG. 3e shows the data carrier according to FIG. 3a when being observed under a second viewing angle;

FIG. 3f shows the security element according to FIG. 3a when being observed under the second viewing angle;

FIG. 4a shows a top view on another data carrier comprising a security element according to the invention;

FIG. 4b shows a sectional view through the data carrier according to FIG. 4a at the position B-B;

FIG. 4c shows the data carrier according to FIG. 4a when being observed under a first viewing angle;

FIG. 4d shows the data carrier according to FIG. 4a when being observed under a second viewing angle;

FIG. 5a shows a top view on another data carrier comprising a security element according to the invention;

FIG. 5b shows a sectional view through the data carrier according to FIG. 5a at the position C-C;

FIG. 5c shows the data carrier according to FIG. 5a when being observed under a first viewing angle;

FIG. 5d shows the data carrier according to FIG. 5a when being observed under a second viewing angle;

FIG. 6a shows a top view on another data carrier comprising a security element according to the invention;

FIG. 6b shows a sectional view through the data carrier according to FIG. 6a at the position D-D;

FIG. 6c shows a sectional view through the data carrier according to FIG. 6a at the position E-E;

FIG. 6d shows the data carrier according to FIG. 6a when being observed under a first viewing angle;

FIG. 6e shows the data carrier according to FIG. 6a when being observed under a second viewing angle;

FIG. 6f shows the data carrier according to FIG. 6a when being observed under a third viewing angle;

FIG. 6g shows the data carrier according to FIG. 6a when being observed under a fourth viewing angle;

FIG. 7a shows a top view on a security element according to the invention;

FIG. 7b shows a data carrier comprising the security element according to FIG. 7a when being observed under a first viewing angle;

FIG. 7c shows the data carrier according to FIG. 7a when being observed under a second viewing angle.

### DESCRIPTION OF PREFERRED EMBODIMENTS

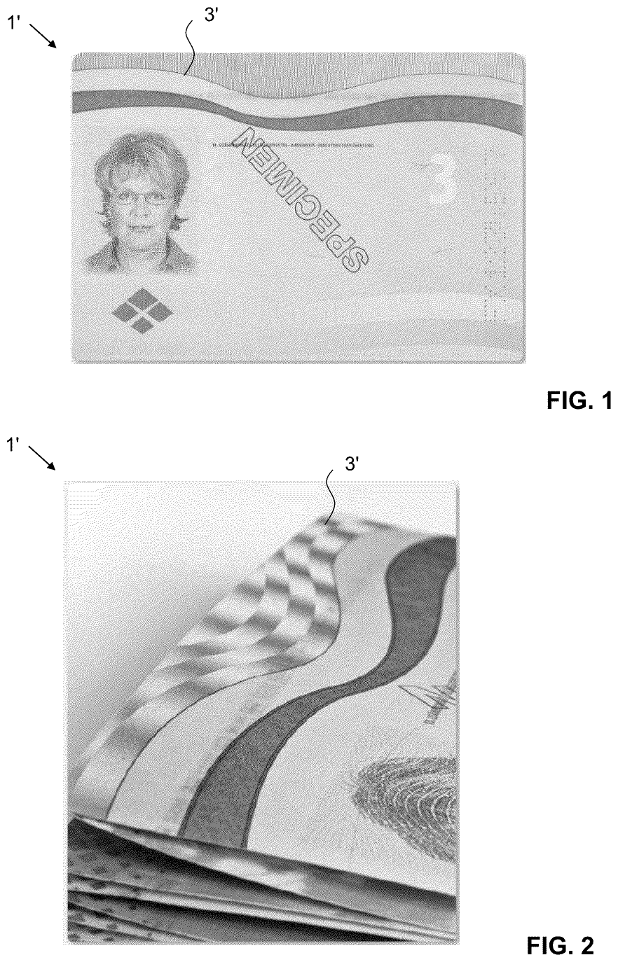

FIGS. 1 and 2 depict examples of a data carrier 1′ comprising a security element 3′ according to the state of the art. Namely, FIG. 1 depicts the 3rd page of the current Finnish passport. The security element 3′ in the form of a blue wavy design next to the edge of the page (topmost part in the image) appears single colored. FIG. 2 depicts the same page when being observed under an angle, wherein the same part of the page that was light blue in FIG. 1 splits into bands of darker and yet lighter blue. In addition the bands move as one tilts the passport in hand and observes it under different angles of observation. This security element 3′ is based on a structured paper surface done with engraved printing plates in the Intaglio printing process and coloring the structure with offset printing. The embossed and printed patterns are in the simplest case just parallel lines that are aligned in direction (no/little relative rotation) and they need to have a slightly different pitch between successive lines. This security element 3′ is called Intaglio Colorshift which is an optically variable security feature.

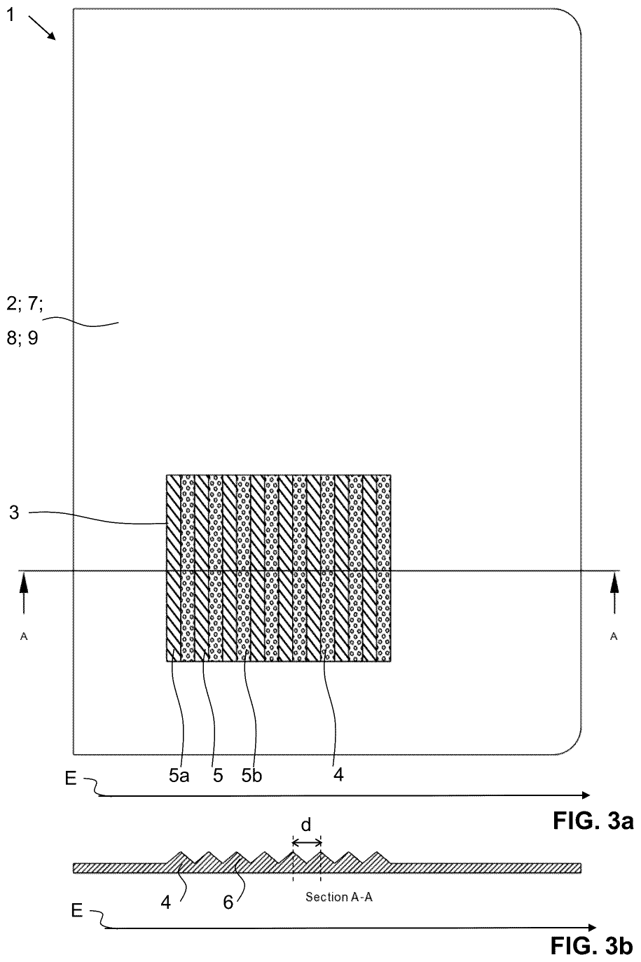

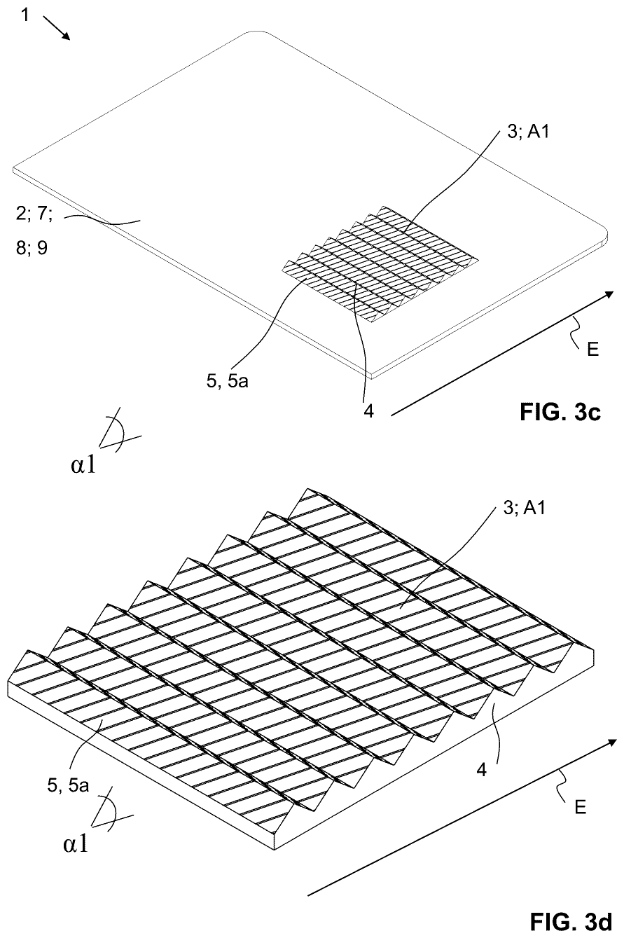

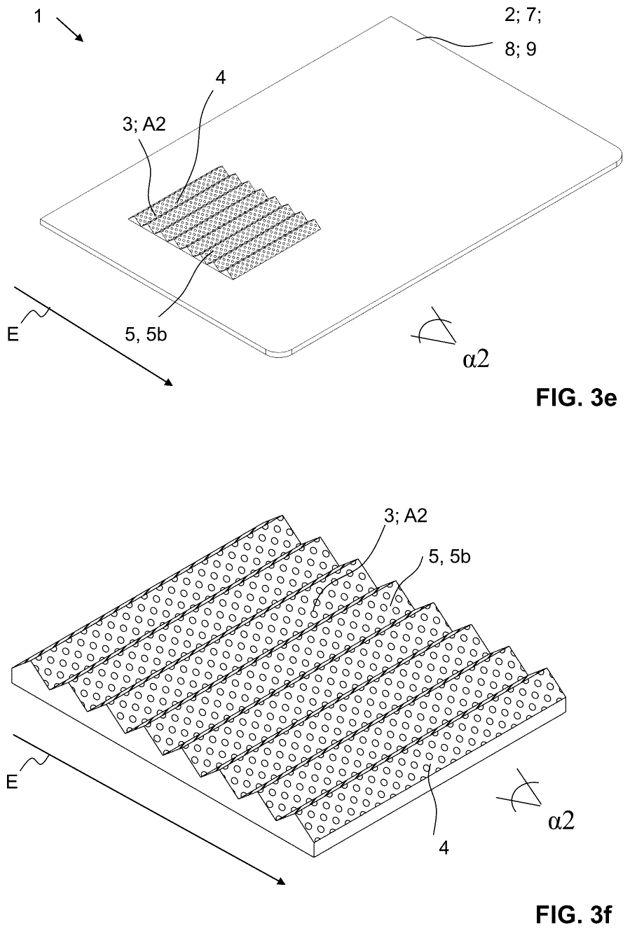

With respect to FIGS. 3a to 6g aspects of a data carrier 1 comprising a security element 3 according to the invention are discussed in greater detail. The security element 3 according to the invention achieves a strong optically variable effect in inkjet personalized images and/or alphanumeric characters on data carriers 1 comprising different carrier bodies 2 such as on polycarbonate but also on paper.

Hence, and as follows from these figures, the data carrier 1 according to the invention comprises a carrier body 2 and security element 3 being provided on the carrier body 2. The security element 3 comprises here one surface structure 4 extending along an extension direction E and a print such as an inkjet print 5 being arranged on the surface structure 4. The security element 3, in the region of the surface structure 4, is configured to exhibit different appearances A1, A2, . . . when being observed under different viewing angles α1, α2, . . . .

In FIGS. 3a to 3f, the security element 3, in particular its surface structure 4, is provided on a top side 7 of the data carrier 1, in particular on a top surface 9 of the data carrier 1. The top surface 9 of the data carrier 1 is provided here by a top surface 8 of the carrier body 2. The surface structure 4 can be generated in various ways. For instance, it can correspond to a laser marking or an embossing or a print being generated in or applied on the top surface 9 of the data carrier 1.

As furthermore follows from these figures, the surface structure 4 comprises elevations 6 extending away from the carrier body 2, in particular from the top surface 8 of the carrier body 2, towards an outside of the data carrier 1. In the depicted examples the surface structure 4 is a symmetrical surface structure, wherein a distance d between, a surface area of and a slope of the elevations 6 remains constant with respect to the extension direction E.

The surface structure 4 is associated with a surface structure pitch. In a regularly repeating surface structure the surface structure pitch corresponds to the wavelength equivalent for the surface structure. Hence, in the depicted example the surface structure pitch corresponds to the distance between the top (or bottom) of the elevations. If the structure is composed of varying width of the ridges then the pitch is a variable quantity as well. Moreover, the inkjet print 5 is associated with a printing resolution. In the depicted examples, the surface structure pitch and the printing resolution match one another and are in perfect register with one another.

FIGS. 3a to 3f depict a security element 3 comprising an inkjet print 5 that comprises two different inkjet colours 5a, 5b, namely a first inkjet colour 5a being designated by lines and a second inkjet colour 5b being designated by circles. When seen along the extension direction E a density of these inkjet colours 5a, 5b varies. Namely, only the first inkjet colour 5a is arranged on regions of the elevations 6 comprising an increasing slope with respect to the extension direction E. On these regions, the density of the second inkjet colour 5b is zero. The second inkjet colour 5b however is arranged on regions of the elevations 6 comprising a decreasing slope with respect to the extension direction E. On these regions, the density of the first inkjet colour 5a is zero. In other words, the first inkjet colour 5a and the second inkjet colour 5b are arranged in an alternating manner with respect to the extension direction E.

Hence, when the data carrier 1 is observed from a top view, both inkjet colours 5a, 5b will be visible, see FIGS. 3a and 3b. However, when the data carrier 1 is observed from another viewing angle only one of the inkjet colours is visible. For instance, when the data carrier 1 is observed from a bottom to top view along a viewing angle α1 as depicted in see FIGS. 3c and 3d, only the first inkjet colour 5a is visible, whereby the security element 3 exhibits a first appearance A1. When the data carrier 1 is observed from a top to bottom view along a viewing angle α2 as depicted in FIGS. 3e and 3f, however, only the second inkjet colour 5b is visible, whereby the security element 3 exhibits a second appearance A2. Hence, the appearance A1, A2 of the security element 3 changes according to the viewing direction and thus according to the viewing angle.

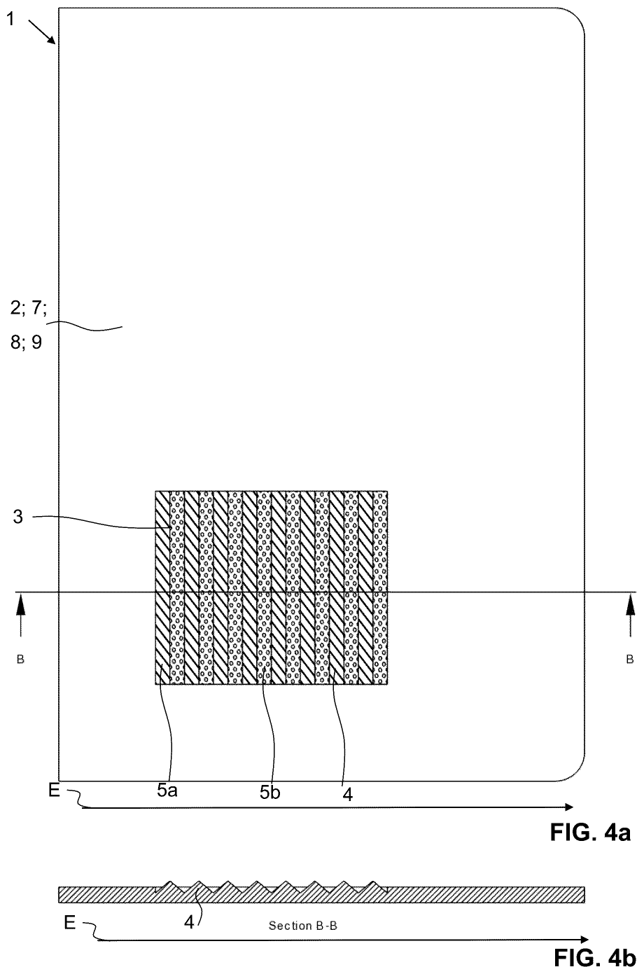

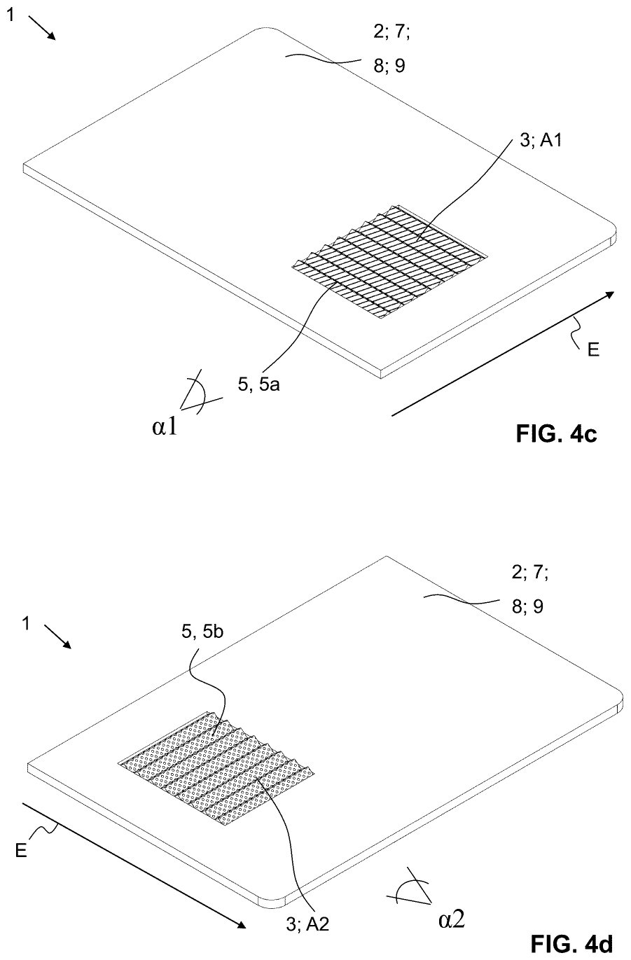

The data carrier 1 depicted in FIGS. 4a to 4d differs from the data carrier 1 depicted in FIGS. 3a to 3f in that its security element 3 comprises a surface structure 4 that extends above as well as below a reference plane running through the top surface 8 of the carrier body 2. Other characteristics are however the same. That is, the inkjet print 5 comprises two different inkjet colours 5a, 5b whose density varies when seen along the extension direction E. Namely, only the first inkjet colour 5a is arranged on regions of depressions comprising an increasing slope with respect to the extension direction E. On these regions, the density of the second inkjet colour 5b is zero. The second inkjet colour 5b however is arranged on regions of the depressions comprising a decreasing slope with respect to the extension direction E. On these regions, the density of the first inkjet colour 5a is zero. In other words, the first inkjet colour 5a and the second inkjet colour 5b are arranged in an alternating manner with respect to the extension direction E. Hence, when the data carrier 1 is observed from a top view, both inkjet colours 5a, 5b will be visible, see FIGS. 4a and 4b. However, when the data carrier 1 is observed from another viewing angle only one of the inkjet colours is visible. For instance, when the data carrier 1 is observed from a bottom to top view along a viewing angle α1 as depicted in FIG. 4c, only the first inkjet colour 5a is visible, whereby the security element 3 exhibits a first appearance A1. When the data carrier 1 is observed from a top to bottom view along a viewing angle α2 as depicted in FIG. 4d, however, only the second inkjet colour 5b is visible, whereby the security element 3 exhibits a second appearance A2. Hence, the appearance A1, A2 of the security element 3 changes according to the viewing direction and thus according to the viewing angle.

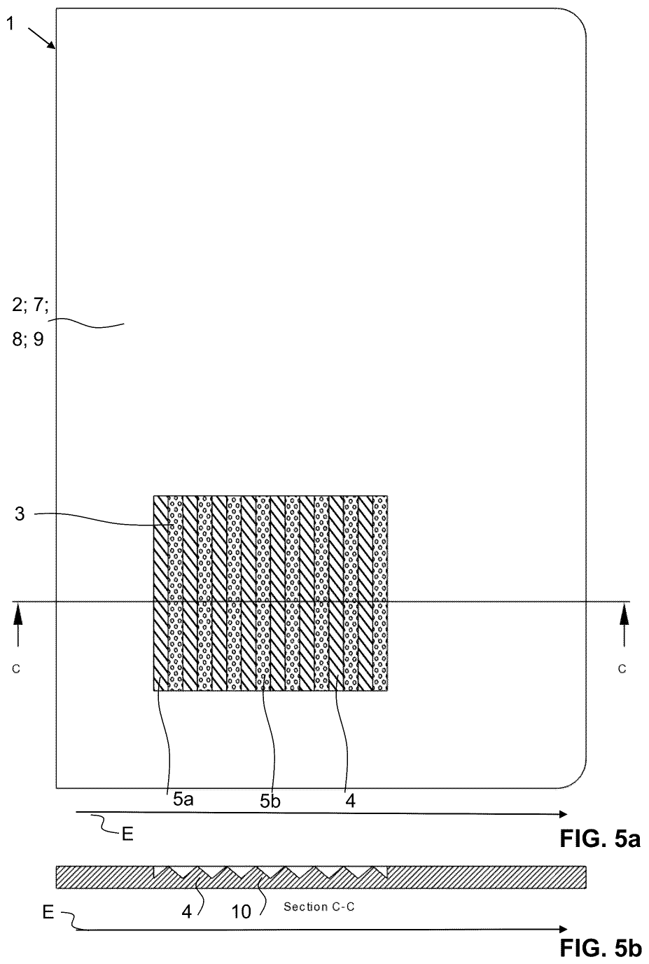

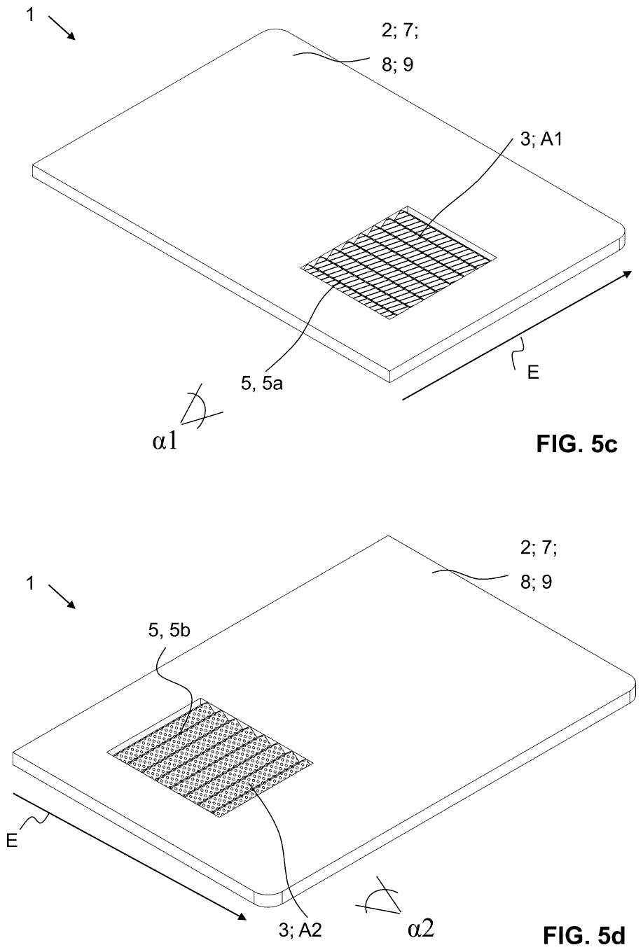

The data carrier 1 depicted in FIGS. 5a to 5d in turn comprises a security element 3 whose surface structure 4 extends fully below the reference plane running through the top surface 8 of the carrier body 2. This surface structure 4 can be said to comprise depressions 10 extending into the top surface 8 of the carrier body 2. The security element 3 furthermore comprises an inkjet print 5 comprising again two different inkjet colours 5a, 5b whose density varies when seen along the extension direction E. Namely, only the first inkjet colour 5a is arranged on regions of depressions 10 comprising an increasing slope with respect to the extension direction E. On these regions, the density of the second inkjet colour 5b is zero. The second inkjet colour 5b however is arranged on regions of the depressions 10 comprising a decreasing slope with respect to the extension direction E. On these regions, the density of the first inkjet colour 5a is zero. In other words, the first inkjet colour 5a and the second inkjet colour 5b are arranged in an alternating manner with respect to the extension direction E. Hence, when the data carrier 1 is observed from a top view, both inkjet colours 5a, 5b will be visible, see FIGS. 5a and 5b. However, when the data carrier 1 is observed from another viewing angle only one of the inkjet colours is visible. For instance, when the data carrier 1 is observed from a bottom to top view along a viewing angle α1 as depicted in FIG. 5c, only the first inkjet colour 5a is visible, whereby the security element 3 exhibits a first appearance A1. When the data carrier 1 is observed from a top to bottom view along a viewing angle α2 as depicted in FIG. 5d, however, only the second inkjet colour 5b is visible, whereby the security element 3 exhibits a second appearance A2. Hence, the appearance A1, A2 of the security element 3 again changes according to the viewing direction and thus according to the viewing angle.

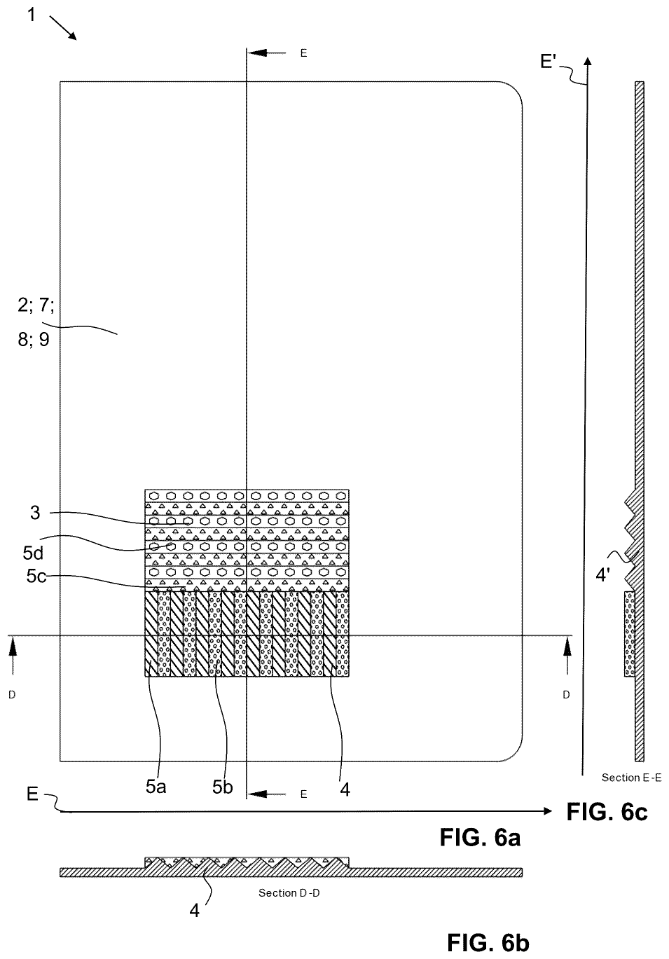

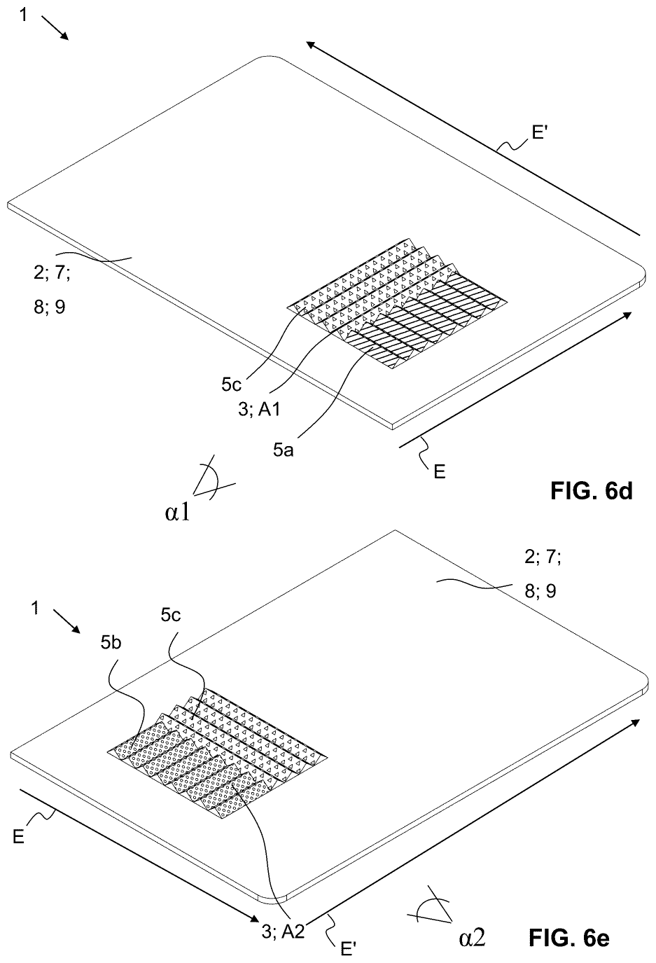

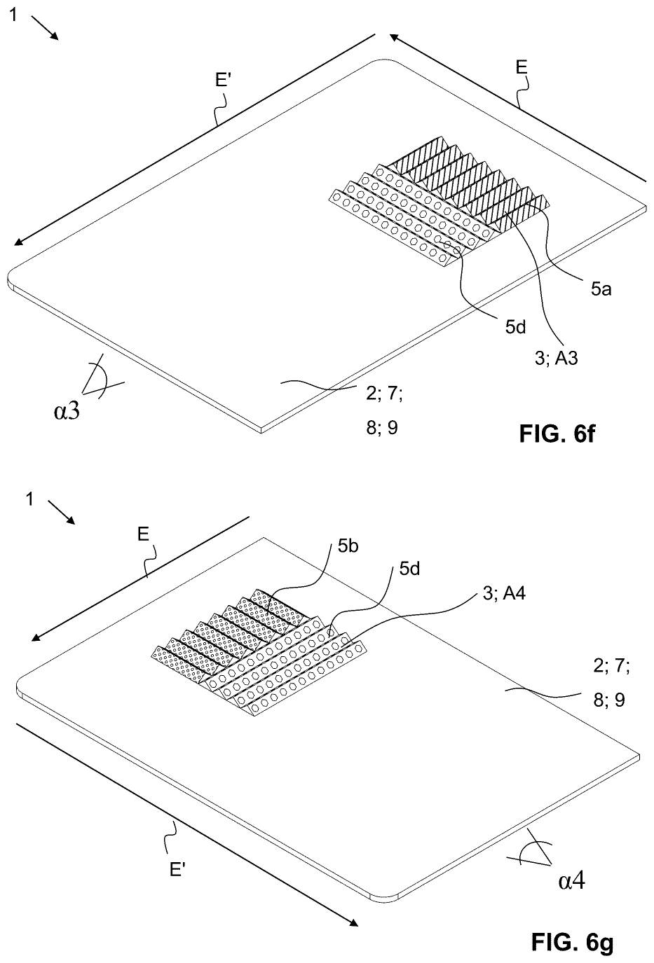

FIGS. 6a to 6g depict a data carrier 1 comprising a security element 3 that has a surface structure 4 and a further surface structure 4′, wherein the further surface structure 4′ extends along a further extension direction E′ being different from the extension direction E. In particular, the extension direction E and the further extension direction E′ run perpendicular to one another. Both surface structures 4, 4′ extend above a reference plane running through the top surface 8 of the carrier body 2 and are furthermore arranged immediately adjacent to one another, see FIGS. 6b and 6c. The inkjet print 5 is arranged on the surface structure 4 as well as on the further surface structure 4′. To this end, the inkjet print 5 comprises four different inkjet colours 5a, 5b, 5c, 5d being designated here by means of lines, small circles, large circles and triangles, respectively. Two of these inkjet colours 5a, 5b and 5c, 5d are in each case arranged on one of the surface structures 4 and 4′. In fact, a first inkjet colour 5a (designated by lines) and a second inkjet colour 5b (small circles) are arranged on the surface structure 4 and with a varying density with respect to the extension direction E, and a third inject colour 5c (triangles) and a fourth inkjet colour 5d (large circles) are arranged on the further surface structure 4′ and with a varying density with respect to the further extension direction E′, see FIGS. 6a to 6c. As a result, the security element 3 exhibits different appearances A1, A2, A3 and A4 when viewed along different viewing angles α1, α2, α3, α4, compare FIGS. 6d to 6g.

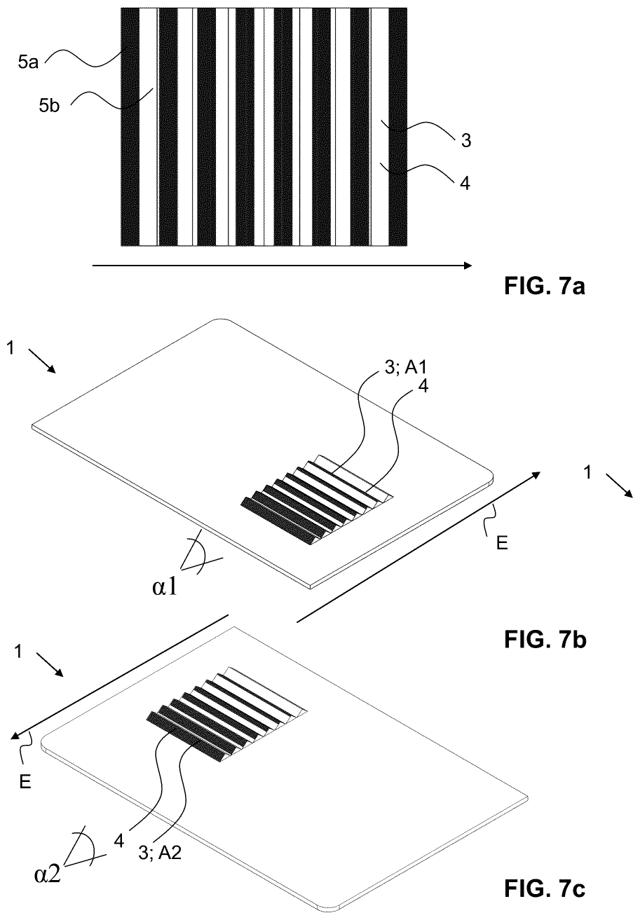

FIGS. 7a to 7c illustrate a security element exhibiting a Moire effect. To this end the security element 3 comprises a surface structure 4 extending along the extension direction E, and wherein the surface structure 4 comprises a surface structure pitch that does not match the printing resolution of the inkjet print 5. In particular, a first inkjet colour 5a of a darker color tone and a second inkjet colour 5b of a lighter color tone are not in register with the surface structure pitch of the surface structure 4. This mismatch results in the Moire effect, wherein the data carrier 1 exhibits different appearances when being observed under a first viewing angle α1, see FIG. 7b, and a second viewing angle α2, see FIG. 7c.

Hence, the present invention enhances the security of an inkjet print such as a main photograph on a data carrier such as a passport datapage or on an ID card. In this case, the surface structure may cover the whole surface of the inkjet print as it is the case in the depicted example, or a part of it or only partly overlap with the inkjet print.

Furthermore, and in the depicted example the whole inkjet print ‘interacts’ with the surface structure. However, it is likewise conceivable that only some color(s) of the inkjet print or spatially only a particular part of the inkjet print such as the photograph representing the document holder, or that only the background of the photograph ‘interacts’ with the surface structure. The outcome could for example be that the inkjet print in the form of a photograph such as the part representing the document holder looks the same from all viewing angles but that the background breaks into varying colors and/or apparent motion when tilting the data carrier.

Hence, in summary it can be said that the present invention provides extra security to inkjet prints such as printed photographs/data on a security document by linking parts of the security element such as the surface structure in the form of a tactile laser marking and the inkjet print or the carrier body and the inkjet print in the event of a surface structure being an embossing together for an easy to verify effect feature. Additionally, the surface structure renders a removal of the inkjet print more difficult. Furthermore, the present invention does not require extra techno bricks or equipment but just image preprocessing, printing, and possibly plastic or paper surface embossing as it is known in the art.

### LIST OF REFERENCE SIGNS

| | |
|---|---|
| 1, 1′ | data carrier |
| 2 | carrier body |
| 3, 3′ | security element |
| 4, 4′ | surface structure |
| 5 | inkjet print |
| 5a, 5b, . . . | inkjet colour |
| 6, 6′ | elevation |
| 7 | top side |
| 8 | surface |
| 9 | top surface |
| 10 | depression |
| A1, A2, . . . | appearance |
| a1, a2, . . . | viewing angle |
| E, E′ | extension direction |
| d | distance |

What is claimed, is:

1. A data carrier for a secure article such as a passport comprising:
a carrier body; and
at least one security element being provided on the carrier body; wherein
the security element comprises at least one surface structure extending along at least one extension direction (E) and at least one print such as an inkjet print being at least partially arranged on the surface structure,
wherein the security element, in the region of the surface structure, is configured to exhibit different appearances (A1; A2) when being observed under different viewing angles (α1; α2).

2. The data carrier according to claim 1, wherein the surface structure comprises elevations extending away from the carrier body and/or depressions extending towards the carrier body.

3. The data carrier according to claim 2, wherein a distance (d) between and/or a surface area of and/or a slope of the elevations remains constant or changes with respect to the extension direction (E), and/or
wherein a distance between and/or a surface area of and/or a slope of the depressions remains constant or changes with respect to the extension direction (E).

4. The data carrier according to claim 3, wherein the surface structure is associated with a surface structure pitch and wherein the print is associated with a printing resolution, the surface structure pitch and the printing resolution matching or mismatching one another.

5. The data carrier according to claim 1, wherein the print comprises at least a first colour, and
wherein a density of the first colour on the surface structure remains constant or varies with respect to the extension direction (E), and/or
wherein the first colour and the surface structure are arranged in a spatial relationship with one another.

6. The data carrier according to claim 1, wherein the print comprises at least a first colour and a second colour being different from the first colour, and
wherein a density of said first colour on the surface structure equals or differs from a density of said second colour on the surface structure with respect to the extension direction (E).

7. The data carrier according to claim 1, wherein an image and/or an alphanumeric character to be printed as the print in an initial state before being printed on the surface structure is associated with an initial appearance being provided by at least a first colour and a second colour, and
wherein the first colour and the second colour are arranged on the surface structure with different densities such, that the security element exhibits an appearance corresponding to the initial appearance when being observed under a first viewing angle while exhibiting a different appearance when being observed under a different viewing angle.

8. The data carrier according to claim 1, wherein the data carrier further comprises at least one marking material being configured to interact with impinging laser radiation, and wherein the surface structure corresponds to a laser marking being generated in the marking material.

9. The data carrier according to claim 1, wherein the carrier body and/or the surface structure comprises or consists of one or more paper-based compounds and/or one or more cardboard-based compounds and/or one or more plastics and/or one or more polymers, preferably one or more thermoplastics and/or amorphous polymers, particularly preferably polycarbonate and/or polycarbonate blends and/or polycarbonate co-extrudates, and/or
wherein the surface structure corresponds to a print, preferably an inkjet print.

10. The data carrier according to claim 1, wherein the data carrier defines a top side, and
wherein the security element is provided on the top side the data carrier.

11. The data carrier according to claim 1, further comprising at least one further surface structure being different from the surface structure, and wherein the print is furthermore at least partially arranged on said further surface structure.

12. The data carrier according to claim 11, wherein the further surface structure extends along the extension direction (E) or along at least one further extension direction (E′) being different from the extension direction (E), and/or
wherein the further surface structure comprises further elevations extending away from the carrier body and/or further depressions extending towards the carrier body with respect to the further extension direction (E′), and wherein at least one of a distance, a surface area, a slope, a cross-section or a surface structure pitch of the further elevations and/or of the further depressions equals or differs from at least one of the distance, the surface area, the slope, the cross-section or the surface structure pitch of the elevations and/or of the depressions of the surface structure.

13. The data carrier according to claim 11, wherein the print comprises at least a first colour, and wherein a density of the first colour on the surface structure with respect to the extension direction (E) equals or differs from a density of the first colour on the further surface structure with respect to the extension direction (E) and/or the further extension direction (E′), and/or
wherein the print comprises at least a first colour being arranged on the surface structure and a further colour being arranged on the further surface structure, the first colour and the further colour differing from one another.

14. The data carrier of claim 1 is contained in a secure article, wherein the secure article is an identity card, a passport, a credit card, a smart card, a driving license, or a data page.

15. A method of producing a data carrier for a secure article suitable for use as a passport, wherein the method comprises the steps of:
Providing a carrier body; and
Providing at least one security element on the carrier body; wherein
the security element comprises at least one surface structure extending along at least one extension direction (E) and a print such as an inkjet print being at least partially provided on the surface structure,
wherein the security element, in the region of the surface structure, is configured to exhibit different appearances (A1; A2) when being observed under different viewing angles (α1; α2).

16. The method according to claim 15, further comprising the step of providing at least one marking material being configured to interact with impinging laser radiation on the carrier body and generating the surface structure as a laser marking by irradiating laser radiation onto the marking material.

17. The method according to claim 15, further comprising the step of embossing preferably a structure on a lamination plate into a surface of the carrier body and generating the surface structure as embossing, wherein the print and the embossing are preferably generated based on a same data set being input to a printer such as an inkjet printer and a lamination device comprising the lamination plate.

18. The method according to claim 15, further comprising the step of printing, in particular inkjet printing, the surface structure onto the surface of the carrier body.
